(19) United States
(12) Patent Application Publication
(10) Pub. No.: US 2019/0281946 A1
(43) Pub. Date: Sep. 19, 2019

(54) LAMP FOR CURING NAIL GEL

(71) Applicants: Ryan Kim, Alpharetta, GA (US); Chin Hao Chang, New Taipei City (TW)

(72) Inventors: Ryan Kim, Alpharetta, GA (US); Chin Hao Chang, New Taipei City (TW)

(21) Appl. No.: 16/353,799

(22) Filed: Mar. 14, 2019

Related U.S. Application Data
(60) Provisional application No. 62/642,832, filed on Mar. 14, 2018.

(51) Int. Cl. A45D 29/18; F21V 17/16

(52) U.S. Cl. CPC A45D 29/18; F21Y 2115/10; F21V 17/16

(57) ABSTRACT

The present invention relates to a lamp for use in curing gel polish applied to nails, such as fingernails or toenails. The lamp includes a housing having an opening for receiving, at least, a part of a hand including one or more fingers or a part of a foot including one or more toes. The lamp also includes one or more retractable feet attached to a bottom of the housing adjacent a front end thereof for elevating the front end of the housing so as to facilitate the insertion or removal, or the proper positioning, of the part of the foot or the hand in or from the opening of the housing. The lamp also includes a bottom plate and a mechanically releasable mechanism for removably attaching the bottom plate to the bottom of the housing.

### CROSS-REFERENCE TO RELATED APPLICATIONS

This application claims the benefit of U.S. Provisional Application No. 62/642,832, filed Mar. 14, 2018, the disclosure of which is incorporated herein by reference in its entirety.

### FIELD OF THE INVENTION

The present invention relates to lamps for curing nail gel.

### BACKGROUND OF THE INVENTION

Lamps are presently available for curing gel polish applied to fingernails or toenails. Improvements are being made for enhancing various functionalities of conventional nail gel curing lamps.

### SUMMARY OF THE INVENTION

The present invention relates to a lamp for use in curing gel polish applied to nails, such as fingernails or toenails. The lamp includes a housing having an opening for receiving, at least, a part of a hand including one or more fingers or a part of a foot including one or more toes. The lamp also includes one or more retractable feet attached to a bottom of the housing adjacent a front end thereof for elevating the front end of the housing so as to facilitate the insertion or removal, or the proper positioning, of the part of the foot or the hand in or from the opening of the housing. The lamp also includes a bottom plate and a mechanically releasable mechanism for removably attaching the bottom plate to the bottom of the housing.

### BRIEF DESCRIPTION OF THE DRAWINGS

In the drawing figures, which are not to scale, and where like reference numerals indicate like elements throughout the several views:

FIG. 1 is a bottom perspective view of a nail gel curing lamp constructed in accordance with an embodiment of the present invention;

FIG. 2 is a perspective view of one of a plurality of retractable feet utilized in the lamp of FIG. 1 in accordance with one embodiment;

FIGS. 3 and 4 are schematic diagrams illustrating the operation of the retractable feet shown in FIGS. 1 and 2 in accordance with one embodiment;

FIG. 5 is an in-operation view of the lamp shown in FIG. 1 in accordance with one embodiment; and

FIG. 6 is a schematic diagram illustrating a process for attaching a bottom plate to the lamp shown in FIG. 1 in accordance with one embodiment.

### DESCRIPTION OF EMBODIMENTS OF THE INVENTION

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, and some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; exemplary embodiments are provided merely to be illustrative. Among other things, for example, subject matter may be embodied as methods, devices, components, or systems. The following detailed description is, therefore, not intended to be taken in a limiting sense.

Throughout the specification and/or claims, terms may have nuanced meanings suggested or implied in context beyond an explicitly stated meaning. Likewise, the phrase “in one embodiment” as used herein does not necessarily refer to the same embodiment and the phrases “in another embodiment” and “other embodiments” as used herein do not necessarily refer to a different embodiment. It is intended, for example, that covered or claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

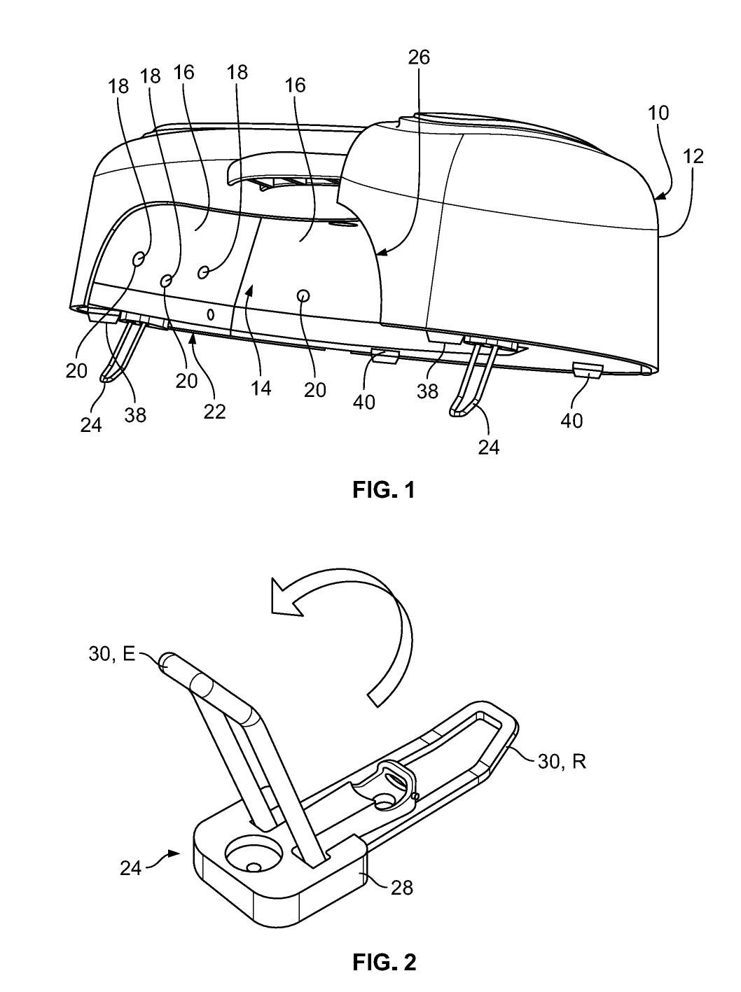

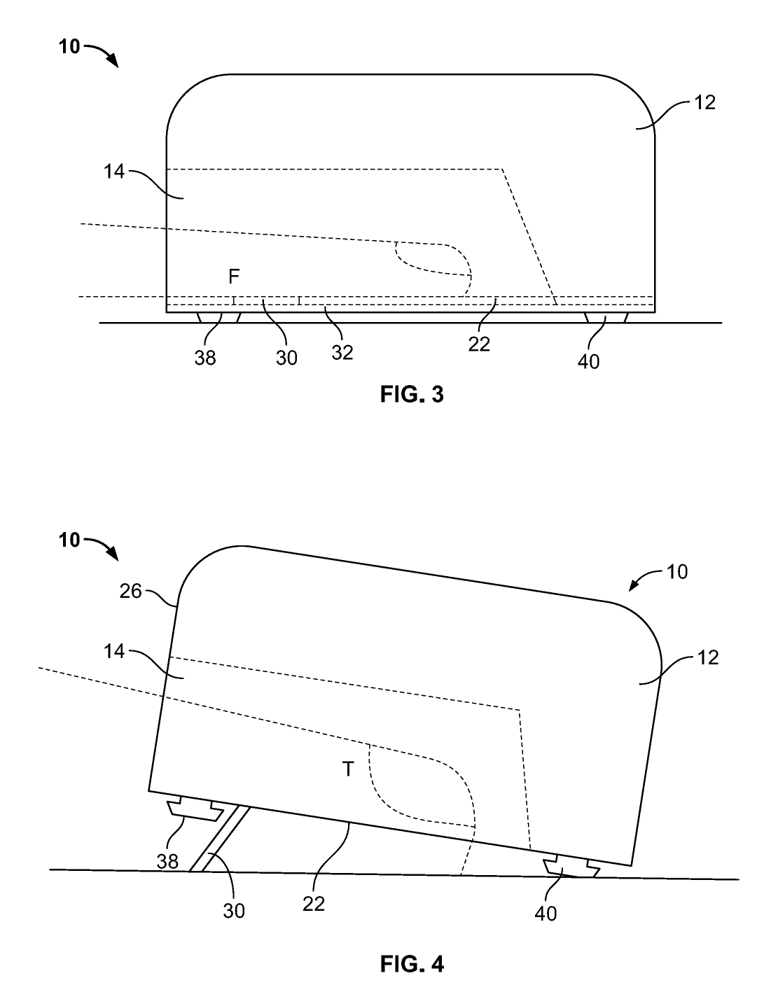

Referring to FIG. 1, there is shown a lamp 10 for curing nail gel in accordance with one embodiment. More particularly, the lamp 10 includes a housing 12 having an opening 14 for receiving, at least, a part of a hand including one or more fingers F or a part of a foot including one or more toes T (see FIGS. 3 and 4). The housing 12 has one or more internal walls 16 defining the opening 14, which is open to the bottom of the housing 12. Light elements 18 (such as light emitting diodes or LEDs) are secured internally in the housing 12 and positioned and arranged such that when they are activated (i.e., turned on), they emit light (e.g., UV light) through corresponding holes 20 formed in the internal walls 16 for curing or hardening nail gel (or gel polish) applied to fingernails or toenails. In one embodiment, each of the internal walls 16 defining the opening 14 has a matte (i.e., substantially non-shiny or non-reflective) finish, while the lighting elements (e.g., LEDs) 18 are provided with a power rating (e.g., 42W) that is higher than that of lighting elements in a conventional nail gel curing lamp.

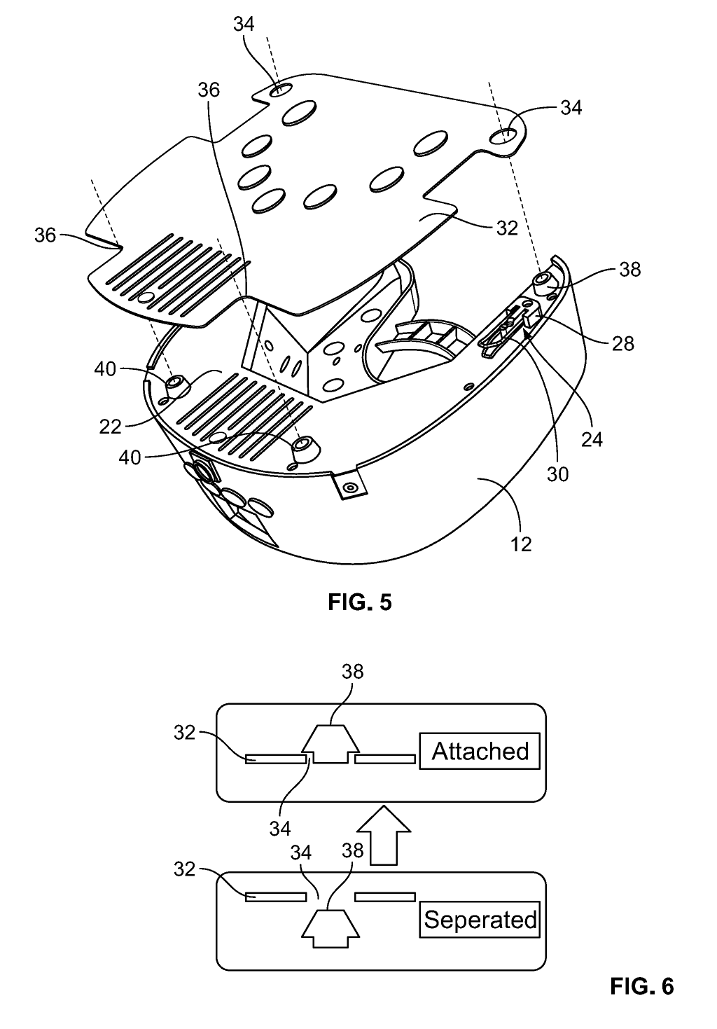

Still referring to FIG. 1, the housing 12 has a bottom side or wall 22 (see also FIGS. 3-5) and one or more feet 24 attached to the bottom side 22 adjacent a front end 26 of the housing 12 (i.e., the end at which the opening 14 opens to the outside). One of the feet 24 is attached to the bottom side 22 adjacent one lateral side of the housing 12, while the other feet 24 is attached to the bottom side 22 adjacent an opposite later side of the housing 12. Each of the feet 24 has a base 28 (see FIGS. 2 and 5), which is fixedly attached to the bottom side 22 of the housing 12, and a retractable foot member 30, which is pivotally attached to a corresponding one of the bases 28. As a result, each of the foot members 30 is adapted to move between a retracted position, in which it lies substantially parallel to the bottom side 22 (see the foot member 30 labeled by the letter “R” in FIG. 2; see also FIG. 3), and an extended position, in which it projects downward from the bottom side 22 (see the foot member 30 labeled by letter “E” in FIG. 2; see also FIG. 4).

With reference to FIG. 5, the housing 12 includes a bottom removable tray or plate 32 having a plurality of mounting holes 34 and a plurality of mounting notches 36. The housing 12 also includes a plurality of bottom supports 38, 40 secured to the bottom side 22 thereof for supporting the housing 12 on a supporting surface, such as a table or a floor. Each of the bottom supports 38, 40 is adapted to engage the bottom plate 32 when the bottom plate 32 is applied to the bottom side 22 so as to removably attach the bottom plate 32 to the housing 12 (see FIGS. 5 and 6). In one embodiment, the bottom plate 32 is snap-fitted onto the bottom side 22 of the housing 12 via the bottom supports 38, 40. In one embodiment, each of the bottom supports 38, 40 is provided with a predetermined shape and/or structure (e.g., a frusto-conical shape) and is made from a flexible material, such as a rubber, so as to facilitate the removable engagement between the bottom plate 32 and the bottom supports 38, 40. In one embodiment, each of the holes 34 receives a corresponding one of the bottom supports 38 in a snap-fit manner (see FIG. 6), while each of the notches 36 receives a corresponding one of the bottom supports 40 in a snap-fit manner.

In one embodiment, when the lamp 10 is used to cure nail gel applied to fingernails, it is used with the bottom plate 32 removably attached to the housing 12 and held in place by the bottom supports 38, 40, as illustrated in FIG. 3. To allow the bottom plate 32 to be applied to the bottom side 22 of the housing 12, the foot members 30 are in their retracted positions.

In one embodiment, when the lamp 10 is used to cure nail gel applied to toenails, it is used without the bottom plate 32 attached to the housing 12. In order to use the lamp 10 in this manner, each of the foot members 30 is moved from its retracted position to its extended position such that when the lamp 10 is placed on a supporting surface (such as a floor), its front end is 26 is lifted up or elevated so as to facilitate the insertion or removal of a portion of a foot including toes in and from the opening 14, as illustrated in FIG. 4. In one embodiment, the lamp 10 may be used to cure nail gel applied to fingernails without the bottom plate 32 attached to the housing 12.

It is noted that the lamp 10 may have numerous modifications and variations. In one embodiment, the bottom plate 32 may be eliminated completely. In another embodiment, the bottom plate 32 may be removably attached to the housing 12 via other mechanical mechanisms, such as other snap-fit mechanisms. In yet another embodiment, the feet 24 may be provided with other mechanisms, such as telescoping mechanisms, to raise the front end 26 of the housing 12.

It will be understood that the embodiments described herein are merely exemplary and that a person skilled in the art may make many variations and modifications without departing from the spirit and scope of the invention. All such variations and modifications are intended to be included within the scope of the invention.

I claim:

1. A lamp device for use in curing gel polish applied to at least one nail, comprising a housing having a bottom and a front end, said housing having an opening sized and shaped for receiving, at least, a part of a hand including one or more fingers or a part of a foot including one or more toes; a bottom plate; an attaching mechanism for removably attaching said bottom plate to said bottom of said housing; and at least one retractable foot attached to said bottom of said housing adjacent said front end for elevating said front end of said housing so as to facilitate insertion or removal of the part of the foot or the hand in or from said opening of said housing when said bottom plate is detached from said bottom of said housing.
